(19) United States
(12) Patent Application Publication
(10) Pub. No.: US 2006/0096545 A1
(43) Pub. Date: May 11, 2006

(54) Pet feeder apparatus

(76) Inventors: Danny Joe Cone, Anderson, SC (US); Minnie Belle Duvall, Anderson, SC (US)

Correspondence Address: MCNAIR LAW FIRM, P.A., P.O. BOX 10827, GREENVILLE, SC, 29603-0827, US

(21) Appl. No.: 11/267,367

(22) Filed: Nov. 4, 2005

Related U.S. Application Data
(60) Provisional application No. 60/625,066, filed on Nov. 5, 2004.

(51) Int. Cl. A01K 5/01

(52) U.S. Cl. 119/61.53

(57) ABSTRACT

The invention is directed towards a pet feeder that provides a barrier between the food contained within the feeder and ants or other crawling insects. The invention comprises a lower water container, a support element carried by the lower water container and supporting an upper feed container, a hood element and a rain collector. The rain collected by the rain collector drains down the support element and into the lower water container replenishing a water source for the animal and the insect barrier. The hood element protects the food contained in the height-adjustable upper feed container from becoming wet with rain.

### CROSS REFERENCE TO RELATED PATENT

This application is based on and claims priority from provisional patent application Ser. No. 60/625,066 filed on Nov. 5, 2004.

### BACKGROUND OF THE INVENTION

This invention relates to an animal feeder that may be disposed upon the ground or suspended in air by hanging the feeder. More particularly, the invention relates to an animal feeder having elements in vertically spaced relation that provide a barrier to materially alleviate insect infestation of the food contained in the feeder.

The pet feeders in the prior art provide barriers that prevent insect infestation. Some of these feeders combine the food dish with the water dish, where the food dish is supported on a pillar(s) which rises out of the water in the water dish. In some embodiments of this type of feeder the food dishes are offset from center so that the support pillar may be shortened considerably still leaving room for the animal to drink from the lower water dish.

Other feeders in the prior art include feeding dishes having a moat that is disposed around the circumference of a feeding dish which is contained in a carrier apparatus having feet to keep the moated dish off of the ground.

Still other feeders in the prior art provide insect-proof pet bowls having an outer liner and an inner liner that conforms to the outer liner but that has upwardly extending sides that angle away from the sides of the outer liner and thereby forms a gap. The gap formed by the upwardly extending sides of the outer and inner liner forms a barrier to the crawling insects. In this type of feeder, the tip of the outer liner extends beyond the tip of the inner liner so that if the bowl is pushed against an object, such as a wall, direct access to the inner liner bowl is prevented.

Other feeders utilize a pet feeder comprising a base member, an upstanding support rod for carrying the food dish and a liquid receptacle secured to the support rod for placing corn oil in the liquid receptacle to prevent ants and other crawling insects from reaching the support plate and/or the food dish secured thereon.

All though the above described prior art has provided certain improvements in pet food feeders that may reduce insect infestation, improvement is needed in that the prior art in that it lacks a means of protecting the pet food from other elements encountered outside such as rain. Further, the feeders in the prior art require that the liquid used to repel the insects be replaced. Finally, the feeders disclosed in the prior art are useful only for land animals such as dogs and cats but lack the ability to provide a feeder to be used by air borne animals such as birds.

Accordingly, it is the material object of the present invention to provide yet further improvements over the prior art.

### SUMMARY OF THE INVENTION

The present invention provides protection from crawling insects and comprises a pet feeder apparatus for providing protection from crawling insects comprising a lower water container for containing a liquid that provides a barrier to crawling insects and a water source for a pet, a support conduit having an internal fluid passageway formed between a first end and a second end of the support conduit, the first end being carried by the lower water container such that it extends vertically out of the liquid, an upper feed container carried by the support conduit above the lower water container for containing food for the pet, a hood element carried by the second end of the support conduit spaced above the upper feed container for shielding the food from rain water, a rain collector integral with the hood element, having a diameter greater than the diameter of the upper feed container but less than the diameter of the lower water container, for collecting the rain water, a drain disposed in the rain collector for allowing the collected rain water to drain into the internal fluid passageway of the support conduit and into the lower water container thus replenishing the water source for the pet and the barrier to the crawling insects.

In one embodiment, the support conduit comprises at least two interconnectable sections and a drain including a cap having a first end and a second end and a plurality of openings formed between the first end and the second end for allowing water to flow through the cap and into the drain.

In another embodiment, the invention further includes hanging means carried by the first end of the cap for suspending the invention in air in a hanging position and a stabilizing means carried by the lower water container for stabilizing the pet feeder apparatus when in the hanging position.

In another embodiment, the second end of the support conduit extends through the rain collector into the second end of the cap and includes a plurality of openings that align with the plurality of openings in the cap when threaded into the second end of the cap thus allowing the collected rain water to flow through the cap and into the fluid passageway of the support conduit.

In another embodiment, the second end of the support conduit may be coupled to the cap by a coupler, where the coupler includes a plurality of openings aligning with the plurality of openings in the cap for allowing the collected rain water to pass through the coupler and into the internal fluid passageway of the support conduit.

In a further embodiment, the invention further includes a flange integral with the lower water container and having a first end adapted to receive the first end of the support conduit and a second end having a plurality of openings for allowing the rain water to pass through the flange and into the lower water container. The first end of the support conduit is carried by the flange.

In another embodiment, the invention further includes an upper feed container that is slideably carried by the support conduit and a slideable support disposed on the support conduit for carrying the upper feed container.

### DESCRIPTION OF THE DRAWINGS

The present invention will be better understood from the following description taken in conjunction with the accompanying drawings.

FIG. 1 is cross-sectional view illustrating the relationship and assembly of the elements of the present pet feeder invention;

FIG. 2 is an exploded side elevation view illustrating the relationship and assembly of the elements of an alternate embodiment of the invention;

FIG. 3 is an exploded side elevation view illustrating another alternate embodiment of the pet feeder invention; and

FIG. 4 is an exploded side elevation view illustrating an alternative embodiment of the lower portion showing a cut away in the first container that includes a hook eye for stabilization for certain uses.

### DESCRIPTION OF A PREFERRED EMBODIMENT

This animal feeder invention relates to a domestic animal feeder and more in particular to one that needs to supply food and water for several days without becoming infested with fire ants.

The problem brought about by this particular species of ant is that it violently lashes back at pets with venomous stings that can be fatal. As the pets attempt to feed, ant accessible food becomes a motive for this ant to take over confining environment provided by owner for the protection of the animal.

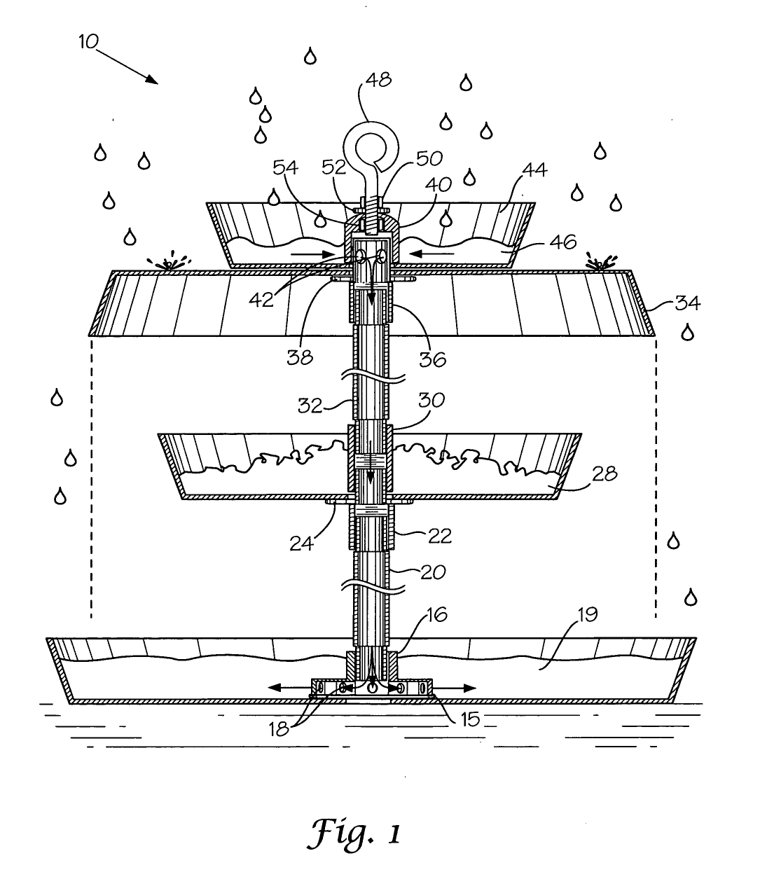

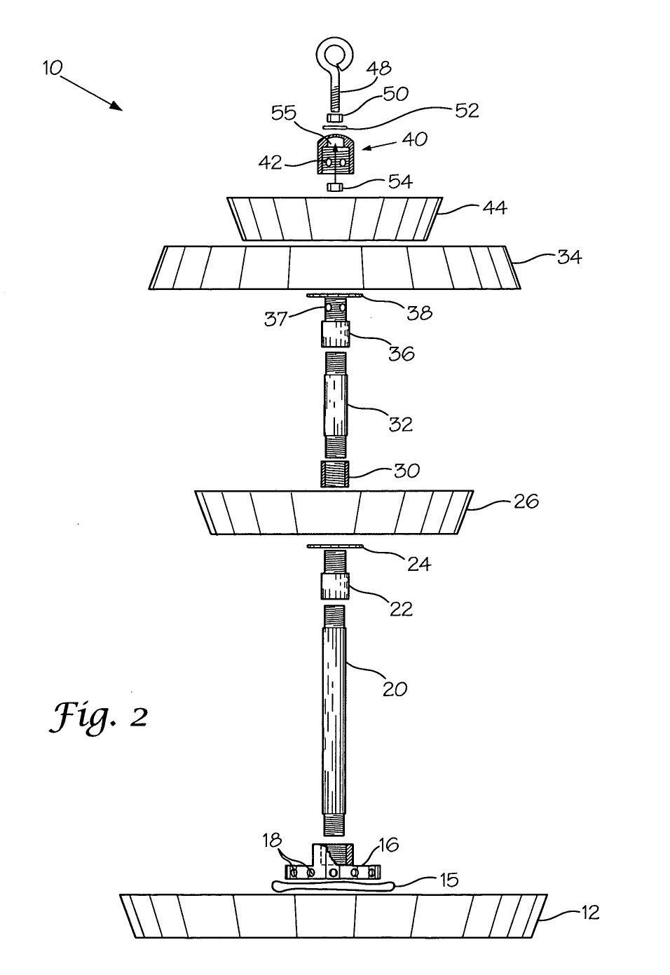

This animal feeder, generally shown at 10 in FIGS. 1 and 2, comprises a large lower water bowl 12, for containing water 14. In at least one embodiment lower water bowl 12 is sixteen inches wide. Lower water bowl 12 constitutes a base that serves as a substantial anchor that supports a flange 16 that is secured to the lower water bowl 12 with adhesive (shown as 15 in FIG. 2) or other suitable means known in the art. In at least one embodiment, epoxy is used to secure flange 16 to lower water bowl 12. Flange 16 is internally threaded to receive and engage the first end of a hollow pipe 20 that is externally threaded on both the first and second ends. Flange 16 also has a plurality of holes in the bottom, allowing liquids to pass through flange 16. The internal threading of flange 16 stops just above the lower portion of flange having a plurality of holes 15. However, in at least one alternate embodiment the first threaded end hollow pipe 20 could extend to the bottom of flange 15 and have openings that align with the opening formed in second end of flange 16 to allow water to flow into the lower water container 12.

The second end of hollow pipe 20 is connected to the first end of a riser 22 that is capped with a washer 24. Riser 22 is internally threaded on the first end to receive and engage hollow pipe 20. Riser passes through an opening (not shown) in a feed bowl 26, that is supported by riser 22 and hollow pipe 20. The opposite end of riser is externally threaded to be received and engaged by a coupler 30. Coupler 30 is hollow and internally threaded throughout to receive and engage the second end of riser 22 and the first end of a second hollow pipe 32.

The second end of second hollow pipe 32 is connected to the first end of a second riser 36. The second riser is substantially identical to the first riser 22 except that it has a plurality of openings 37 formed in the second, externally threaded end of the second riser. Again, the second end of second riser 36 is provided with a washer 38 and supports a hood 34 for sheltering the food within feed bowl 26 from the rain. Second riser 36 extends through an opening (not shown) in hood 34 and a rain collector 44 that is located on top of hood 34. A threaded cap 40 has an opening in the top for receiving a hook eye 48. Hook eye 48 is secured to threaded cap 40 by a first nut 54 located in a recess 55 formed in the top of threaded cap 40 and a second nut 50 located on the top of the threaded cap 40. A washer 52 is located between second nut 50 and threaded cap 40 to provide additional stability.

Threaded cap 40 is provided with a plurality of openings 42 in its sides that align with openings 37 provided in the second, externally threaded end of the second riser 36. These openings allow the rain water that has been collected by rain collector 44 to flow down hollow pipes 20 and 32 to flange 16 and out of the openings 15 provided therein into lower water bowl 12. While the shown embodiment includes openings 37 in the second end of the second riser, threaded cap 40 could have internal threading that would prevent the second riser 36 from obscuring the openings 42 provided in the threaded cap 40 when received by threaded cap, thus alleviating the need for the openings 37 in the second riser 36. Further, while the shown embodiment includes a threaded cap, any drain member generally know in the art could be used.

In at least one embodiment, the hood 34 has a diameter that is greater than the feed bowl 26 but a less than the lower water bowl 12. Thus, when it rains, any rain water not collected by rain collector 44 drips into the lower water bowl, while keeping the food in the feed bowl 26 dry, as shown in FIG. 1.

Referring now to FIG. 2, in at least one alternate embodiment the hollow pipes 20 and 32 have varying lengths. By having two support elements which are inter-connectable through the use of a riser 22 and a coupler 30, the user may vary the height of the feed bowl 26 in relation to the lower water bowl 12 and the hood element 34. This ability provides the advantage of adjusting the height of the feed bowl to be consistent with the height of animal feeding from the invention as well as adjusting the height of the entire apparatus.

When a larger animal such as a Great Dane feeds from the apparatus, it is desirable to have the feed bowl 26 vertically spaced farther from the lower water bowl to accommodate the height of the dog. Further because of the large diameter of the dog's head, it may further be desirable to vertically space the hood element 34 farther from the feed bowl 26 to allow the dog to gain access to the food. The user may want to lower the feed bowl 26, however, when a small dog such as a Chihuahua feeds from the apparatus.

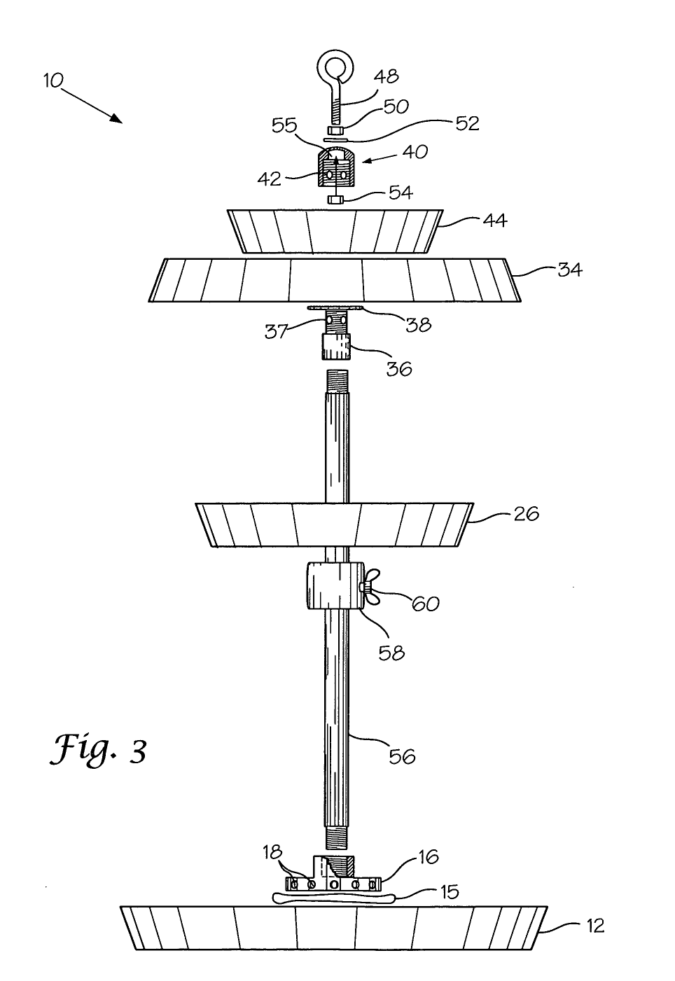

Referring now to FIG. 3, in at least one embodiment, the support element comprises a single hollow pipe 56. By having a single support element rather than a sectional support element as shown in FIGS. 1 and 2, the feed bowl 26 may be slideably connected to the support element 56. A slideable support 40 is provided to allow the feed bowl 26 to be slideably attached to the support element. In the shown embodiment, slideable support 40 is a collar that is adapted to slideably fit over hollow pipe 18. Slideable support is further provided with a means for engaging hollow pipe to lock the slideable support into place such as a screw 41, however, any means of engaging pipe may be used as the slideable support 40 such friction fit clips. This embodiment provides the advantage of being able to adjust the height of feed bowl in relation to the lower water bowl and hood element simply by adjusting the slideable support 40.

Regardless of the embodiment, in use, the lower water bowl 12 is filled with water and thus provides an insect barrier to the food located in feed bowl 26. Hood 34 provides the food shelter from the rain. Rain collector 44 collects rain water that is allowed to flow through the openings 42 in the threaded cap 40 down the hollow pipes 20 and 32. Because the internal threading of flange 16 ensures that hollow pipe does not block the plurality of openings 15 formed in the flange by stopping short of the plurality of openings 15, water is allowed to flow out of the flange's openings 15 and into the lower water bowl 12. Thus, every time it rains, the lower water bowl is replenished with water. While the water serves as an insect barrier, it also provides a source of water for the pet using the invention. Any rain not collected will drip from the hood element 34 and into lower water bowl 12. If the rain is heavy, lower water bowl 12 will over flow, which serves as a means of cleaning the lower water bowl of debris such as food or leaves that have fallen in the water bowl.

Hook eye 48 allows the invention to be suspended in the air in a hanging position. This feature allows the invention to be hung at a low level allowing a four legged animal such as a cat or dog to feed or to be hung at a higher level to serve as a bird feeder and/or a bird bath. The uniqueness of this invention is its ability to protect all two and four-footed animals from becoming infested with crawling insects and thereby making the food uneatable by the animal.

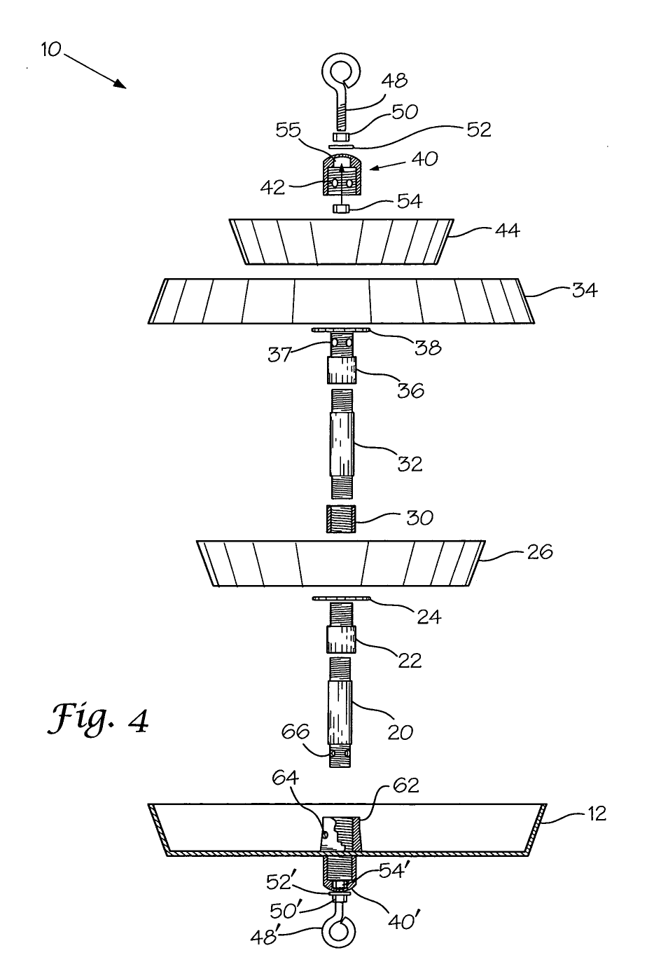

As shown in FIG. 4, when the invention is suspended in air in a hanging position, an alternate embodiment of the invention provides a second hook eye 48′ or other suitable securing means for providing additional stability to the invention when in a hanging position. In this embodiment, the hook eye 48′ is carried by the bottom of the lower water bowl 12 so that a wire can be secured to an object located below the invention to prevent unnecessary swinging or swaying of the invention. In the shown embodiment, the lower hook eye 48′ is carried by the lower water bowl 12 in substantially the same manner as the upper hook eye 48 is carried by the rain collector. Second hook eye 48′ is carried by a lower threaded cap 40′ using two nuts 52′ and 54′ and a washer 52′. Since hollow pipe 20 must now pass entirely through flange 64 so as to engage lower threaded cap 40′, hollow pipe 20 has a plurality of openings 17 in a first end that is to pass through flange 62 and be received and engaged by lower threaded cap 40′. The plurality of holes 17 in hollow pipe align with the plurality of openings 64 in flange to allow water to flow into lower water bowl when engaged with flange 62 and lower threaded cap 40′. Further, in this embodiment flange 62 is internally threaded throughout to allow the first end of hollow pipe 20 to extend entirely through flange 64. This embodiment also alleviates the need for an adhesive to secure flange to the lower water bowl, as it will be disposed between lower threaded cap 40′ and hollow pipe 20.

Modifications to the present invention may occur to those of ordinary skill in the art. Accordingly, it is to be understood that the present invention is not limited to the particular embodiments disclosed herein, but rather is intended to cover all modifications within the scope of the present invention as set forth in the following claims.

What is claimed is:

1. A pet feeder apparatus for providing protection from crawling insects comprising:
a lower water container for containing a liquid that provides a barrier to said crawling insects and a water source for a pet;
a support conduit having an internal fluid passageway formed between a first end and a second end of said support conduit, said first end being in fluid communication with said lower water container and being carried by said lower water container such that it extends vertically out of said liquid;
an upper feed container carried by said support conduit above said lower water container for containing food for said pet;
a hood element carried by said second end of said support conduit spaced above said upper feed container for shielding said food from rain water;
a rain collector integral with said hood element for collecting said rain water;
a drain disposed in said rain collector for allowing said collected rain water to drain into said internal fluid passageway of said support conduit and into said lower water container thus replenishing said water source for said pet and said barrier to said crawling insects.

2. The pet feeder apparatus of claim 1 wherein said support conduit comprises at least two interconnectable sections.

3. The pet feeder apparatus of claim 1 wherein said drain comprises a cap having a first end and a second end and a plurality of openings formed between said first end and said second end for allowing said rain water to flow through said cap into said drain.

4. The pet feeder apparatus of claim 3 further comprising hanging means carried by said first end of said cap for suspending the pet feeder apparatus in air in a hanging position.

5. The pet feeder apparatus of claim 4 further comprising a stabilizing means carried by said lower water container for stabilizing said pet feeder apparatus when in said hanging position.

6. The pet feeder apparatus of claim 3 wherein said second end of said support conduit extends through said rain collector into said second end of said cap.

7. The pet feeder apparatus of claim 6 wherein said second end of said support conduit includes a plurality of openings that align with said plurality of openings in said cap when threaded into said second end of said cap thus allowing said rain water to flow through said cap and into said fluid passageway of said support conduit.

8. The pet feeder apparatus of claim 3 wherein said second end of said cap and said second end of said support conduit are coupled by a coupler.

9. The pet feeder apparatus of claim 8 wherein said coupler includes a plurality of openings aligning with said plurality of openings in said cap for allowing said rain water to flow through said cap and said coupler and into said internal fluid passage way of said support conduit.

10. The pet feeder apparatus of claim 1 further comprising a flange integral with said lower water container and having a first end adapted to receive said first end of said support conduit and a second end having a plurality of openings for allowing said rain water to pass through said flange and into said lower water container.

11. The pet feeder apparatus of claim 10 wherein said first end of said support conduit is carried by said flange.

12. The pet feeder apparatus of claim 1 wherein said hood element has a diameter that is greater than the diameter of said upper feed container but less that the diameter of said lower water container.

13. The pet feeder apparatus of claim 1 wherein said upper feed container is slideably carried by said support conduit.

14. The pet feeder apparatus of claim 13 further comprising a slideable support disposed on said support conduit for carrying said upper feed container.

15. A pet feeder apparatus for providing protection from crawling insects comprising:
a lower liquid container for containing a liquid that provides a barrier to said crawling insects;
a flange carried by said lower liquid container;
a hollow support conduit having a first section carried by said flange and a second section having a second terminal end and said flange further having a plurality of openings for allowing water to pass from said support element through said flange;
an upper feed container supported by said first section of said hollow support conduit above said lower water container for containing food for the pet;
a hood element supported by said second section of said hollow support conduit above said upper feed container;
a rain collector integral with said hood element for collecting rain water;
at least one opening formed in said terminal end of said second section of said hollow support conduit allowing said rain water to flow into and through said hollow support conduit to said openings in said flange and into said lower liquid container replenishing said liquid and said barrier to said crawling insects.

16. The pet feeder apparatus of claim 15 wherein said first and second sections of said hollow support conduit comprise interconnected detachable sections for easy disassembly.

17. The pet feeder apparatus of claim 16 wherein said second section of said support element has a plurality of openings formed in said second end of said support conduit that align with said plurality of openings in a drain member carried by said second section for allowing said rain water to flow through said drain member and down said support conduit.

18. The pet feeder apparatus of claim 15 wherein said upper feed container is slideably carried by at least one of said first section and said second section of said support element.

19. The pet feeder apparatus of claim 18 further comprising a slideable support disposed on at least one of said first section and said second section of said support conduit for carrying said upper feed container.

20. The pet feeder apparatus of claim 17 further comprising hanging means disposed adjacent said a top end of said drain member.
